(19) United States
(12) Patent Application Publication
(10) Pub. No.: US 2005/0225264 A1
(43) Pub. Date: Oct. 13, 2005

(54) LED lamp with color and brightness controller for use in wet, electrically hazardous bathing environments

(76) Inventor: William Harry Kemp, Clayton (CA)

Correspondence Address: Sequence Controls Inc., 150 Rosamond Street, Carleton Place, ON, K7C 1V2, CA

(21) Appl. No.: 10/811,810

(22) Filed: Mar. 30, 2004

(51) Int. Cl. G05F 1/00

(52) U.S. Cl. 315/291

(57) ABSTRACT

An apparatus operable in a wet environment for controlling the brightness and color of a solid state light emitting diode, lamp assembly which is adapted to be coupled to an AC source for supplying an AC signal. A plurality of switching devices is connected in series with the lamp assembly and light emitting diodes. The switching devices are operative in a first state, wherein significant current flowing through the lamp assembly is prevented or a second analogue state wherein current flow through the lamp assembly is continuously variable. User controls provide lamp assembly brightness and color input signals to a controller. Also included is a controller means for receiving lamp assembly brightness and color input signals from the user controls, and for switching the switching devices between the first and second states in a predetermined sequence for inducing analogue power signals to the lamp assembly. The isolation means for electrically isolating the user controls from the AC source, includes an electrical current barrier.

### FIELD OF THE INVENTION

The present invention relates generally to light emitting diodes and associated methods of color and brightness control. More particularly, the present invention relates to a controller that employs power modulation to vary the relative color and brightness of each of at least one red, green and blue light emitting diode for use in a wet or electrically hazardous environment.

### BACKGROUND OF THE INVENTION

Bathing appliances such as hot tubs, swimming pools, shower units and hydromassage bath fixtures often employ a means of under water lighting to create a desired ambience in the bathing environment. As “ambience” is a subjective description generally relating to color and brightness, it is not possible for one light type to satisfy every user's desired settings.

Prior art underwater bathing lamps are known to utilise electric incandescent bulbs and insulation means. However, such systems often lack the ability to control brightness and are not capable of controlling color output.

It is not practical to install numerous lighting appliances, each with a different brightness and color. Therefore, a means of adjusting the desired parameters of brightness and color would be a desirable feature.

Furthermore, an electrical, incandescent lighting system installed in a wet environment is considered to be hazardous due to the possibility of electrical energy used to operate the light “leaking” into the bathing water and creating a shock hazard.

Another known system includes an arrangement of fiber optics which channel light to outlets located through out the bathing system structure. A bright, white light source is forced into the fiber optic at a location sufficient far away from the bath water that no electric shock hazard will result. The white light transmitted through the fiber optic to the bath water may be made to change color by inserting a color wheel element in between the light source and the entrance to the fiber optic. Rotating the color wheel inserts different colors of filter into the light path, thereby changing the light beam at the bathing appliance. Such systems generally have limited functionality or excessive cost for the features provided.

Alternatively, a triad (meaning a single light source of red, green blue combination or a grouping of any number or combination of red, green and blue light source, typically light emitting diodes) of high luminous output red, green and blue light emitting diodes installed in a suitable chassis and lens assembly may be fitted into the bath structure. When such an arrangement of light emitting diodes are connected to a controller and pulse width modulator (PWM), the output light brightness and color may be adjusted over a very large setting range, creating a useful “ambience”.

A triad grouping of red, green and blue, light emitting diodes coupled to a controller and pulse width modulator provides an effective arrangement for providing adjustable brightness and color of light to a bather in a bathing appliance. Although PWM techniques are well known and provide an effective means of modulating light color and brightness, they are subject to objectionable flicker of the output light energy.

An alternative means of operating the light sources is to use an analogue voltage or current regulator which varies the amount of energy presented to the light source and modulates them accordingly. Although such as design is well known in the prior art and eliminates the issue of flicker, it is very difficult, if not impossible, to calibrate the output light energy between the light sources to ensure highly calibrated color, hue, saturation and brightness.

The power necessary to operate the triad of light emitting diodes or other light source may still be sufficiently great to create a shock hazard to a bather operating the light system's controls or through electrical “leakage” from the chassis assembly, while in the bathing system. Thus, the bather will be in danger of electrocution if not protected from the electric source of the light emitting diodes while operating the light controls or simply being immersed in the bathing water. This creates a practical dilemma as the user cannot convey his commands to the light controller without “bridging” the electrical isolation barrier, putting themselves at risk of shock.

Accordingly, it is an object of the present invention to provide a light control system having a plurality of light emitting diodes with red, green and blue luminous output, a control apparatus and digital to analogue converter incorporating associated methods to control color and brightness of the light for installation in wet, electrically hazardous bathing environments.

Accordingly it is an object of the present invention to provide an improved lighting brightness and color controller.

A further object of the present invention is to provide a solid state lamp assembly consisting of a plurality of red, green and blue light emitting diodes.

A further object of the present invention is to provide a controller utilising an analogue to digital converter and switching device coupled to each of the red, green and blue light emitting diodes individually.

A further object of the present invention is to provide a lighting system controller that is safely operable by a bather immersed in water.

A further object of the present invention is to provide an improved method for controlling the brightness and color of a solid state lamp assembly consisting of a plurality of red, green and blue light emitting diodes.

### SUMMARY OF THE INVENTION

To protect the bather from electric shock, the electrical energy driving the first, second and third light emitting diodes and user control is sufficiently isolated from the bather by providing impedance isolation of the control circuits from the electrically conductive bath water. Impedance isolation may be preferably implemented utilising impedance protected, step-down, isolation transformer.

According to the invention, there is provided an apparatus operable in a wet, electrically hazardous environment, for controlling the brightness and color output of a solid state lamp assembly consisting of a triad of red, green and blue light emitting diodes, which are adapted to be coupled to a controller for supplying a dc control signal, the apparatus comprising:

a first switching device coupled to a first color light emitting diode or grouping, a second switching device coupled to a second color light emitting diode or grouping and a third switching device coupled to the third color light emitting diode or grouping, each of the switching devices being operative in a low impedance state thereby enabling current to flow through the associated light emitting diode of each switching device and an analogue impedance state thereby varying current flow through the associated light emitting diode of each switching device;

a digital to analogue converter for switching each switching device between its high and analogue impedance states;

user controls for providing lamp brightness and color input signals;

a controller means for receiving the lamp brightness and color signals from the user controls and for controlling the digital to analogue converter, in turn switching each switching device between its high and analogue impedance states in a sequence for inducing a change in relative brightness between the first, second and third color light emitting diodes; and isolation means for electrically isolating the user controls from the AC source, wherein the isolation means includes an electrical current barrier.

In an embodiment of the invention, there is provided an apparatus operable in a wet, electrically hazardous environment, for controlling the brightness and color output of a solid state lamp assembly consisting of a triad of red, green and blue light emitting diodes, which are adapted to be coupled to a controller for supplying a dc control signal, the apparatus comprising:

a first switching device coupled to a first color light emitting diode or grouping, a second switching device coupled to a second color light emitting diode or grouping and a third switching device coupled to the third color light emitting diode or grouping, each of the switching devices being operative in a low impedance state thereby enabling current to flow through the associated light emitting diode of each switching device and an analogue impedance state thereby varying current flow through the associated light emitting diode of each switching device;

a digital to analogue converter for switching each switching device between its high and analogue impedance states;

user controls for providing lamp brightness and color input signals;

a controller means for receiving the lamp brightness and color signals from the user controls and for controlling the analogue to digital converter, in turn switching each switching device between its high and analogue impedance states in a sequence for inducing a change in relative brightness between the first, second and third light emitting diodes; and

a first, second and third switching means comprising first, second and third respective transistors and wherein the first transistor is connected in series with the first light emitting diode and has a first base input connected to the analogue to digital. converter “A” output channel means and the second transistor is connected in series with the second light emitting diode and has a second base input connected to the pulse width modulator “B” output channel means and the third transistor is connected in series with the third light emitting diode and has a third base input connected to the pulse width modulator “C” output channel means and where digital to analogue converter input and control channels are respectively connected to the controller means.

According to the invention, there is further provided a method for controlling the brightness and color output of a solid state lamp assembly consisting of a triad of red, green and blue light emitting diodes, which are adapted to be coupled to a controller for supplying a dc control signal, the apparatus comprising:

a first switching device coupled to a first light emitting diode, a second switching device coupled to a second light emitting diode and a third switching device coupled to the third light emitting diode, each of the switching devices being operative in an analogue impedance state thereby enabling current to flow through the associated light emitting diode of each switching device and a high impedance state thereby preventing significant current flow through the associated light emitting diode of each switching device;

a digital to analogue converter for switching each switching device between its high and analogue impedance state;

user controls for providing lamp brightness and color input signals;

a controller means for receiving the lamp brightness and color signals from the user controls and for controlling the digital to analogue converter, in turn switching each switching device between its high and analogue impedance states in a sequence for inducing a change in relative brightness between the first, second and third light emitting diodes; and

isolation means for electrically isolating the user controls from the AC source, wherein the isolation means includes an electrical current barrier means;

the method comprising the steps of:
(a) detecting a user input control signal comprising lamp color and brightness data
(b) generating a series of digital to analogue converter control variables
(c) activating digital to analogue converter with control variables, enabling analogue current to flow through a first, second and third switching device in turn enabling a grouping of red, green and blue light emitting diodes, which are series connected to their respective first, second and third switching devices.

Other advantages, objects and features of the present invention will be readily apparent to those skilled in the art from a review of the following detailed description of the preferred embodiment in conjunction with the accompanying drawings and claims.

### BRIEF DESCRIPTION OF THE DRAWINGS

The embodiments of the invention will now be described with reference to the accompanying drawings, in which;

FIG. 1 is a schematic of the prior art under water lamp, utilising an isolation transformer mean;

FIG. 2 is a schematic of the prior art under water lamp, utilising an optical fiber;

FIG. 3 is a schematic of the prior art pulse width modulation controlled under water lamp.

FIG. 4 is a wave form diagram of the voltage signal output of three channels of a prior art pulse width modulator which, when connected to suitable switching devices and a grouping of red, green and blue Light Emitting Diodes, (LEDs) provides the correct signal ratios for the LEDs to output white light. The wave forms depict timing diagrams for light intensity at nearly fill power and at approximately 50% power;

FIG. 5 is a schematic of one preferred embodiment of the digital to analogue converter based lamp of the present invention; and

FIG. 6 is a flow chart illustrating the digital to analogue control sequence of the controller of the present invention.

With respect to the above drawings, similar references are used in different Figures to denote similar components.

### DETAILED DESCRIPTION OF THE INVENTION

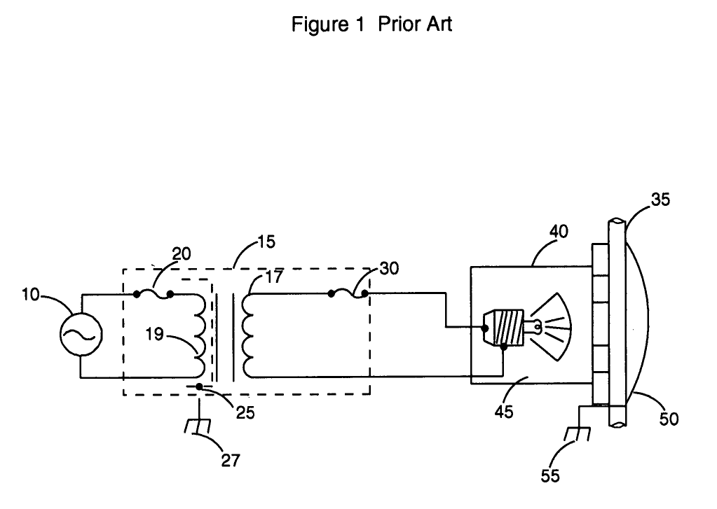

Referring to FIG. 1, there is shown an embodiment of a prior art electrical, incandescent, under water lamp system. In this embodiment an incandescent lamp 45 is connected to the secondary windings 17 of isolation transformer 15, through series current limiting fuse 30. The primary windings 19 of isolation transformer 17 are connected to a source of AC mains voltage 10 through current limiting fuse 20 and are electrically isolated from the secondary windings 17 by ground shield 25. A ground shield 25 completely encloses primary winding 19 and is firmly connected to safety ground 27 to prevent any leakage current from primary winding 19 entering secondary winding 17, and causing a shock hazard. Current limiting fuses 20 and 30 are designed to open should the transformer enter a fault condition which may damage the insulation inherent in windings 17 and 19.

Incandescent lamp 45 is housed in a suitable chassis 40 which is installed in the bathing appliance wall 35. The light output lens 50 contains a suitable metal apparatus that is in turn firmly coupled to a redundant safety ground 55.

While this prior art embodiment is considered to be electrically safe, its construction is often expensive due to the large capacity of isolation transformer 15 required to power incandescent lamp 45. Further, such embodiments offer little if any practical means for lamp brightness or color control.

The prior art embodiment shown in FIG. 1 is typical of most underwater lamp assemblies, varying only in electrical capacity and construction means.

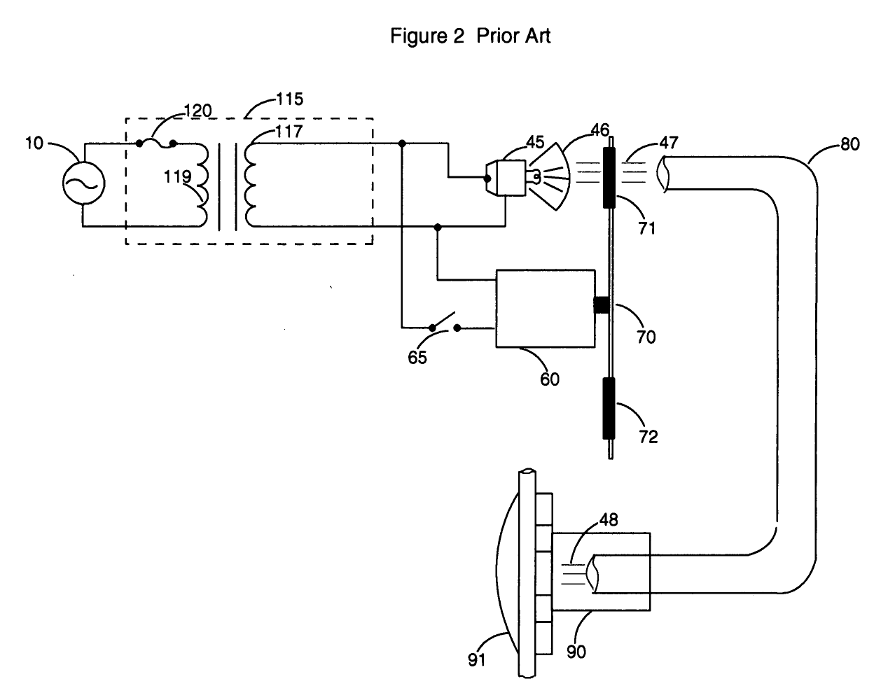

Referring to FIG. 2, there is shown a second embodiment of a prior art underwater lamp system. In this embodiment, the incandescent lamp 45 is coupled to secondary winding 117 of simple isolation transformer 115. Primary winding 119 of isolation transformer 115 is series coupled to over-current fuse 120 and connected to an AC source 10. The light output 46 of lamp 45 is coupled into optical fiber 80. Light emerges 48 from optical fiber 80. Optical fiber 80 is placed in a suitable housing 90, which is in turn mounted in the bath appliance wall 35. Light emerges through lens 91.

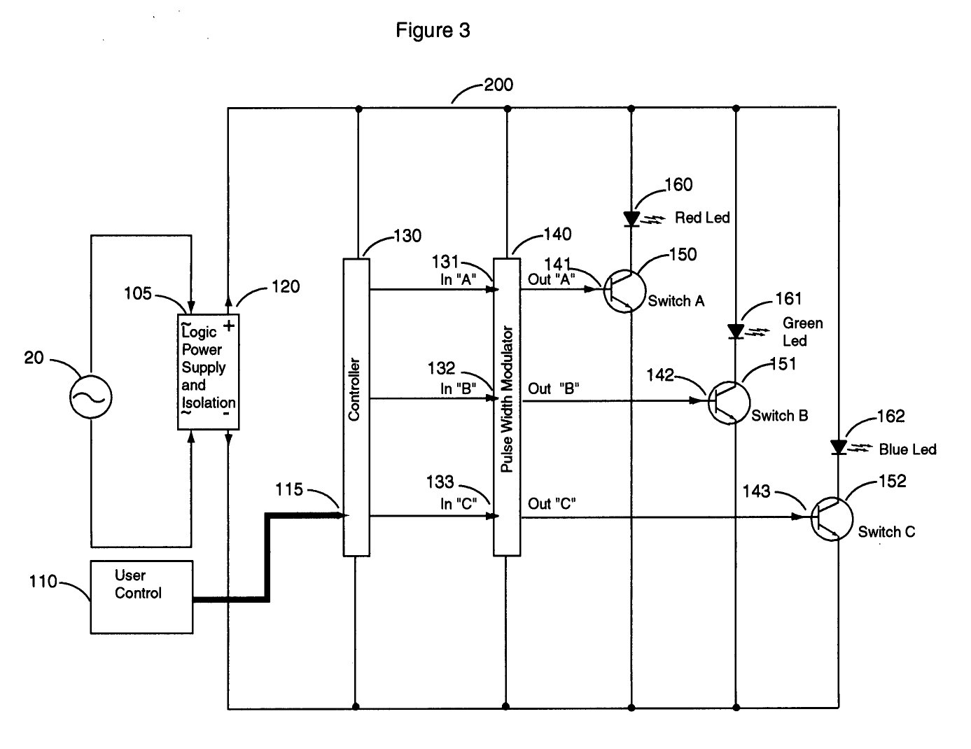

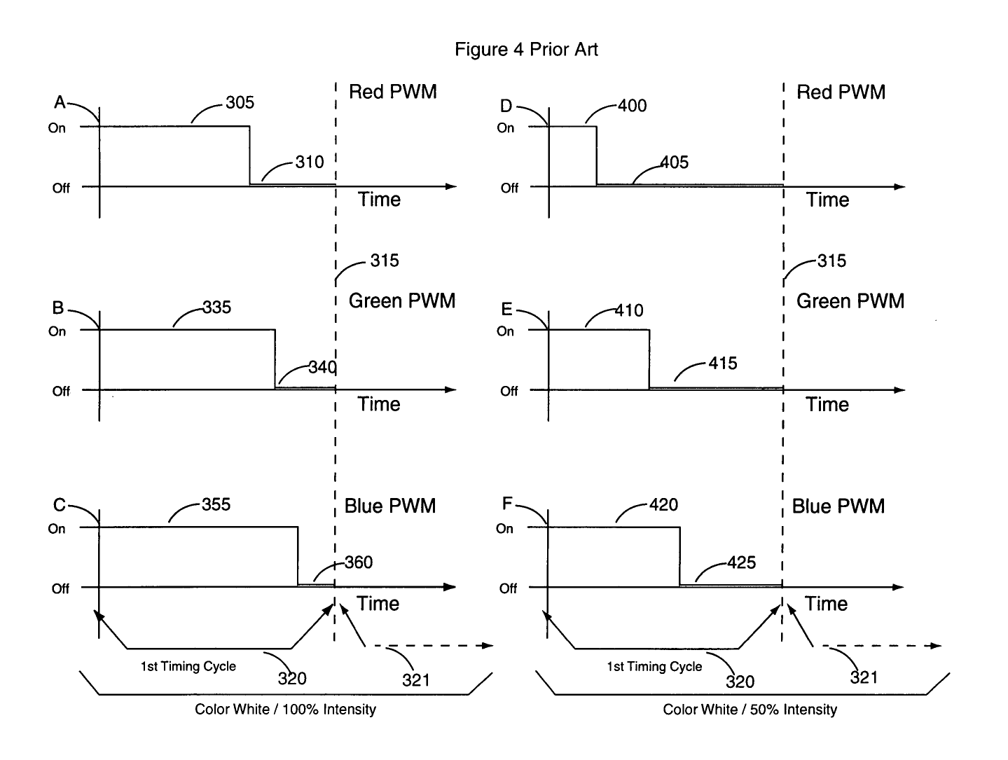

An optional color wheel 70 may be installed in-between lamp 45 and optical fiber 80. This wheel can be manually operated or driven by motor 60 through series connected switch 65. When switch 65 is closed, current flows from the secondary winding 117 of transformer 115 into motor 60. Motor 60 is suitably designed to rotate color wheel 70 to permit different color filters 71, 72 to pass in front of lamp beam 46 and convert filtered output light 47 to the color of lens 71. The use of optical fibre 80 provides an electrical isolation means sufficient to prevent electrocution and results in a simplified isolation transformer 115 and housing 90 as compared to the embodiment shown in FIG. 1. Additionally, the use of optical fiber 80 allows for a color wheel 71 to provide a crude means of color control. The use of optical fibre, color wheels, and complex isolation transformers as noted in FIG. 1 and FIG. 2 is a drawback. Adding such components increases the cost, weight and installation complexity of these prior art lamp systems. Also, the ability to set the “ambience level” of brightness and color is very crude and not generally suitable in the market. Now referring to FIG. 3, there is shown an embodiment of a prior art pulse width modulation lamp controller system 200. An advantage of the controller system 200 is that it does not require the use of incandescent lamps, complex shielded, isolation transformers or mechanical color wheels to generate light and modify its brightness or color. These prior art devices utilise a solid state lamp assembly which is implemented by red, green and blue light emitting diodes 160, 161 and 162, respectively. Suitable devices for light emitting diodes 160, 161, 162 would be high optical brightness LEDs or groupings of lower power devices. For example, the lamp assembly could utilise a quantity of 3 red, 4 green and 5 blue light emitting diodes. The PWM controller varies the brightness of light emitting diodes 160, 161, 162 in relation to each other by a pulse width modulation technique, which is implemented by controller 130 and pulse width modulator 140, which are generally combined in a microcontroller integrated circuit. One such microcontroller is the Motorola MC68HC705GP20 device operating at a crystal frequency of 4 MHz. Such an arrangement of crystal and microcontroller will provide for the orderly processing of input stimuli received from user control 110 and output control to attached peripheral devices such as transistor switch “A” 150. As an alternative, the transistor means may comprise a field effect transistor. The orderly processing of such inputs and outputs are completed by execution of the flowchart patterns shown in FIG. 4. A person skilled in the art will be familiar with microcontrollers such as the Motorola MC68HC705GP20, transistors, field effect transistors and input switch devices.

As described above, the present invention does not require a complex or expensive isolation transformer system owing to the low power requirements of the light emitting diodes 160, 161, 162. One preferable embodiment of the logic power supply 105 is provided by an impedance protected, step-down transformer.

The red, green and blue light emitting diodes 160, 161, 162 may be mounted in a suitable housing that allows their respective light output to converge and “mix”. By varying the brightness in relationship to one another, it is possible to generate an homogenous beam comprising most colors of the visible spectrum. Additionally, if the brightness ratio between the respective light emitting diodes remain the same, but the output optical power is decreased in unison, brightness of the output beam can also be controlled, without modifying color. Obviously if differing numbers of light emitting diodes are utilised or if the optical output power varies, the pulse width modulation ratio between light emitting diodes will have to be adjusted accordingly.

Referring to FIG. 4, a graphical representation of pulse width modulation for a fixed color of white and varying the brightness between 100% and 50% is shown, by way of example. Waveforms (a), (b) and (c) show a digital representation of one time cycle for three synchronised pulse width modulators discussed earlier. Waveforms (a), (b) and (c) represent pulse width modulator outputs 141, 142 and 143 and are the control signals for the red, green and blue light emitting diodes (LED) respectively. Now referring to waveform (a), the start of the first timing cycle 320 indicates that the red LED is activated 305 for approximately 50% of the first timing cycle 320 and deactivated 310 for the remaining 50% of first timing cycle 320. In a similar manner, the green LED control signal shown in waveform (b) is activated for slightly more time 335 than the red LED described in waveform (a) and deactivated 340 for less time than the red LED described in waveform (a). The sum of the activated time 335 and deactivated time 340 of waveform (b) equalling one timing cycle 320. And in a similar manner, the blue LED shown in waveform (c) is activated for slightly more time 355 than the red or green LEDs shown in waveform (a) and (b) respectively and deactivated for less time 360 than either the red or green LEDs. The sum of the activated time 355 and deactivated time 360 of waveform (c) equalling one timing cycle 320. Although the exact characteristics of each physical red, green and blue LED will vary, it is known that the optical power of each color of LED and the apparent intensity due to the response of the human eye to that color, will vary. The example shown in FIG. 4, waveforms (a), (b) and (c) typifies an example where the convergence of the red 160, green 161 and blue 162 optical outputs will cause a response in the human eye of color “white”.

Furthermore, the intensity of the light output for the color white is shown to be near the maximum, because, in this example, the blue 162 LED is activated 355 for nearly 100% of the first timing cycle 320 of waveform (c). Increasing the activation duration of each of red, green and blue to 100% of the first timing cycle would result in greater brightness, but of some different color owing to the different intensity ratios output by the respective LEDs.

Now as further shown in FIG. 4, there is shown a set of waveforms (d), (e) and (f) which represent pulse width modulator outputs 141, 142 and 143 respectively, which also output the color “white” but at an intensity of approximately 50% of that shown in waveforms (a), (b) and (c), described above. By way of this example, the red LED pulse width modulator control signal 141, shown in waveform (d) is now modified to activate 400 for a time approximately 50% of the time in 305. Furthermore, the red LED pulse width modulator 141 is deactivated 405 for a time period approximately twice as long as 310, the sum of activated time 400 and deactivated time 405 being equal to the first timing cycle time 320. In a similar manner, green LED pulse width modulator control signal 142, shown in waveform (e) is now modified such that the activated time 410 and deactivated time 415 are approximately 50% and 200% of the respective time control signals 335 and 340. And in a similar manner, blue LED pulse width modulator control signal 143 is now modified such that the activated time 420 and the deactivated time 425 are approximately 50% and 200% of the respective time control signals 355 and 360. In this manner, the ratio of activated to deactivated time of waveform (d) is approximately 50% that of waveform (a), as is the ratio of activated to deactivated time of waveform (e) to that of waveform (b) and, as is the ratio of activated to deactivated time of waveform (f) to waveform (c). The resulting reduction of activated time by approximately 50% results in a similar decrease in brightness of approximately 50%. Simultaneously, the proportion of activated time 400, 410 and. 420 must remain the same as the proportion of activated time 305, 335 and 355 to maintain the same color. By way of further example, the ratio of activated time 305 to activated time 335 and activated time 305 to activated time 355 must remain the same as reduced brightness, activated time 400 to activated time 410 and activated time 400 to activated time 420, to maintain the same color.

The appropriate ratios described above may be calculated using an algorithm or determined by previous empirical experimentation, with the results stored in the controller 130 means.

It can be seen from the above description that PWM methods of light color and brightness control may be accomplished with a technically simple and effective means. It follows that the majority of solid state LED control systems are based on this technological approach.

The flaw to this technology is the resulting flicker that results from the inherent scanning of the PWM means. Although this may not always be a concern, there are applications where color and light “quality” is very important.

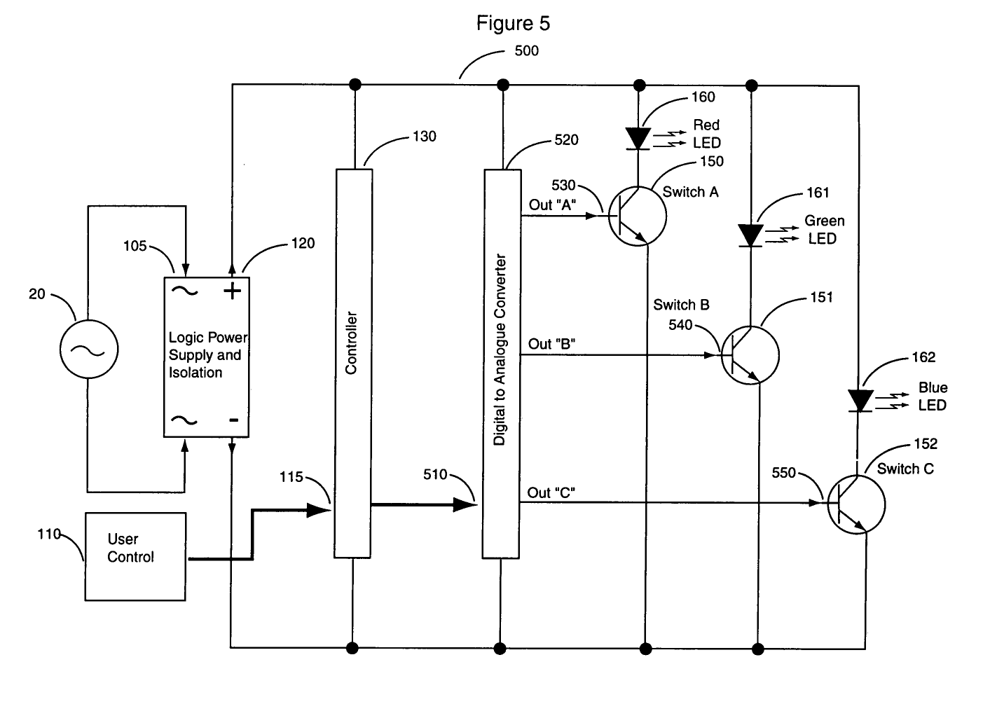

Now referring to FIG. 5, there is shown an embodiment of present invention lamp system 500. An advantage of the system 500 is that it does not require the use of incandescent lamps, complex shielded, isolation transformers or mechanical color wheels to generate light and modify its brightness or color. The present invention utilises a solid state lamp assembly which is implemented by red, green and blue light emitting diodes 160, 161 and 162, respectively.

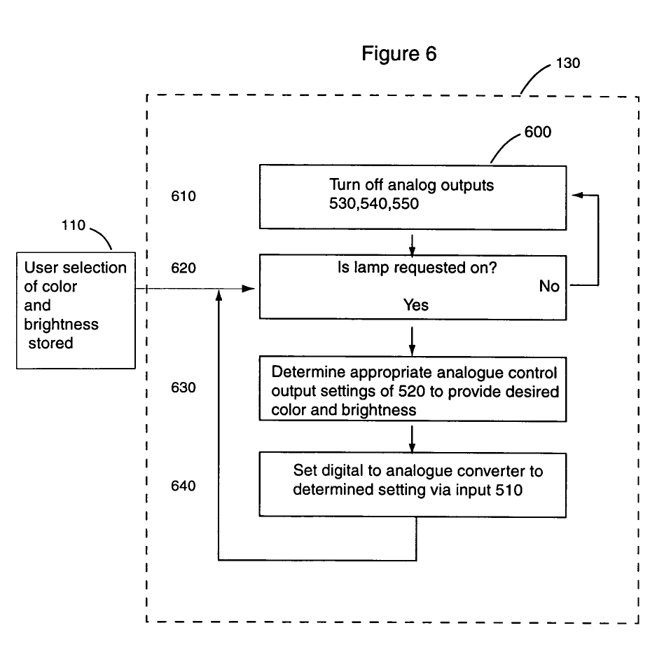

Suitable devices for light emitting diodes 160, 161, 162 would be high optical brightness LEDs or groupings of lower power devices. For example, the lamp assembly could utilise a quantity of 3 red, 4 green and 5 blue light emitting diodes. The analogue controller varies the brightness of light emitting diodes 160, 161, 162 in relation to each other by a power modulation technique, which is initiated by controller 130 and digital to analogue converter 520, which maybe combined in a single microcontroller integrated circuit or in two integrated circuits as outlined in FIG. 5. An arrangement of microcontroller and digital to analogue converter will provide for the orderly processing of input stimuli received from user control 110 and output control to attached peripheral devices such as transistor switch “A” 530. As an alternative, the transistor means may comprise a field effect transistor. The orderly processing of such inputs and outputs are completed by execution of the flowchart patterns shown in FIG. 6. A person skilled in the art will be familiar with microcontrollers, digital to analogue converters, transistors, field effect transistors and input switch devices.

As described above, the present invention does not require a complex or expensive isolation transformer system owing to the low power requirements of the light emitting diodes 160, 161, 162. One preferable embodiment of the logic power supply 105 is provided by an impedance protected, step-down transformer.

The red, green and blue light emitting diodes 160, 161, 162 may be mounted in a suitable housing that allows their respective light output to converge and “mix”. By varying the brightness in relationship to one another, it is possible to generate a homogenous beam comprising most colors of the visible spectrum. Additionally, if the brightness ratio between the respective light emitting diodes remain the same, but the output optical power is decreased in unison, brightness of the output beam can also be controlled, without modifying color. Obviously if differing numbers of light emitting diodes are utilised or if the optical output power varies, the power modulation ratio between light emitting diodes will have to be adjusted accordingly.

An obvious advantage of such an arrangement is the lack of timing signals generated by PWM technologies. This lack of time modulation of the LED currents eliminates flicker and greatly improves the quality and control of the brightness and color.

A person skilled in the art will be familiar with the use of digital to analogue converters operating in a power modulation mode to vary the optical output power of a single light emitting diode. A person skilled in the art will also understand the methods of color mixing and intensity utilising the primary colors of red, green and blue to create alternate colors.

Referring to FIG. 6, a flow chart of the power modulation sequence 600 of the controller 130 is shown. The entry point TURN OFF ANALOGUE OUTPUTS 530, 540, 550, step 610 will cause the controller 130 to disable the digital to analogue converter 520 which will cause output “A” 530, output “B” 540 and output “C” 550 to deactivate, which will cause switch “A” 150, switch “B” 151 and switch “C” 152 to enter a high impedance state, disabling the flow of current in red LED 160, green LED 161 and blue LED 162. Ensuring that switches 150, 151 and 152 are in their off state will turn off the lamp.

In the IS LAMP REQUESTED ON? step 620, the controller 130 will monitor the user control (110) input signal 115. The controller 130 will not advance to the next step until the user requests the lamp to be turned on. The lamp will remain in the off state by the controller executing the loop consisting of TURN OFF ANALGOGUE OUTPUTS 530, 540, 550, step 610 and IS LAMP REQUESTED ON? step 620. When a user selection has been detected in step 620 by user input (110) signal 115, the controller 130 will advance to DETERMINE APPROPRIATE ANALOGUE CONTROL OUTPUT SETTINGS OF 520 TO PROVIDE DESIRED COLOR AND BRIGHTNESS step 630, which will be executed.

In the DETERMINE APPROPRIATE ANALOGUE CONTROL OUTPUT SETTINGS OF 520 TO PROVIDE DESIRED COLOR AND BRIGHTNESS step 530, the controller 130 will determine the power modulation ratios necessary to provide the desired lamp brightness and color. The data may be based on empirical experimentation with the results forming the controller structure or by calculated algorithm. One preferred embodiment of the appropriate modulator ratios used by controller 130 and digital to analogue converter 520 would be to store the data derived from the empirical experimentation described above inside a microcontroller, with integral digital to analogue converter. A person skilled in the art would be familiar with the nature of storing data inside such a microcontroller device. The controller will now load the digital to analogue converter with the resulting LED ratio data by executing SET DIGITAL TO ANALOGUE CONVERTER TO DETERMINED SETTINGS VIA INPUT 510, step 640.

In the SET DIGITAL TO ANALOGUE CONVERTER TO DETERMINED SETTINGS VIA INPUT 510, step 640, the digital to analogue converter will immediately load an analogue control signal on outputs 530, 540 and 550 respectively causing transistor switches 150, 151 and 152 to enter an analogue conduction state, regulating the power through respective series connected LEDs 160, 161 and 162.

As earlier discussed, the output light from the triad of light emitting diodes 160, 161 and 162 will be placed in a manner to combine or “mix” the resulting output light. The user will see the output light beam as an approximately homogenous color of selected brightness.

The controller 130 will execute SET DIGITAL TO ANALOGUE CONVERTER TO ERMINED SETTINGS VIA INPUT 510, step 640 and return to IS LAMP REQUESTED step 620 where upon the power modulation sequence 600 of the controller 130, is repeated.

Numerous modifications, variations and adaptations may be made to the particular embodiments of the invention described above without departing from the scope of the invention, which is defined in the claims.

1. An apparatus operable in a wet environment for controlling the brightness and color of a solid state light emitting diode, lamp assembly which is adapted to be coupled to an AC source for supplying an AC signal, comprising:
a solid state lamp assembly comprising a grouping of at least three different color light emitting diodes;
a plurality of switching devices connected in series with the lamp assembly, light emitting diodes, the switching devices being operative in either a first state wherein significant current flow through the lamp assembly is prevented or a second analogue state wherein current flow through the lamp assembly is continuously variable;
user controls for providing lamp assembly brightness and color input signals;
controller means for receiving lamp assembly brightness and color input signals from the user controls, and for switching the switching devices between its first and second states in a predetermined sequence for inducing an analogue power signal to the lamp assembly; and
isolation means for electrically isolating the user controls from the AC source, wherein the isolation means includes an impedance protected, step-down transformer.

2. An apparatus as defined in claim 1, wherein the solid state lamp assembly comprises a plurality of Light emitting diodes (LED), consisting of one red LED coupled to first switching device, lone green LED coupled to a second switching device and one blue LED coupled to a third switching device.

3. An apparatus as defined in claim 1, wherein the solid state lamp assembly comprises a plurality of Light emitting diodes (LED), consisting of a plurality of red LEDs coupled to first switching device, a plurality of green LEDs coupled to a second switching device and a plurality of blue LEDs coupled to a third switching device.

4. An apparatus as defined in claim 1, wherein the solid state lamp assembly comprises a single Light emitting diode (LED), emitting a plurality of colors being, red, green and blue, including a red color control coupled to a first switching device, a green color control coupled to a second switching device and a red color control coupled to a third switching device.

5. An apparatus as defined in claim 1, wherein the switching device includes a transistor arrangement.

6. An apparatus as defined in claim 1, wherein the switching device includes a field effect transistor arrangement.

7. An apparatus as defined in claim 1, wherein the user controls comprise switches coupled to the controller means.

8. An apparatus as defined in claim 1, wherein the controller means comprises a microcontroller and digital to analogue converter.

9. An apparatus as defined in claim 1, wherein the controller means comprises a microcontroller with internally fabricated digital to analogue converter.

10. An apparatus as defined in claim 1, wherein the isolation means comprises a step-down transformer.

11. A method for controlling the brightness and color of a solid state light emitting diode, lamp assembly, in a wet environment, which is adapted to be coupled to an AC source for supplying an AC signal, comprising:
a solid state lamp assembly comprising a grouping of at least three different color light emitting diodes;
a plurality of switching devices connected in series with the lamp assembly, light emitting diodes, the switching devices being operative in either a first state wherein significant current flow through the lamp assembly is prevented or a second analogue state wherein current flow through the lamp assembly is continuously variable;
user controls for providing lamp assembly brightness and color input signals;
controller means for receiving lamp assembly brightness and color input signals from the user controls, and for switching the switching devices between its first and second states in a predetermined sequence for inducing an analogue power signal to the lamp assembly; and
isolation means for electrically isolating the user controls from the AC source, wherein the isolation means includes an impedance protected, step-down transformer;
the method comprising the steps of:
(a) detecting a user input control signal comprising lamp color and brightness data generating a series of digital to analogue converter control variables
(b) activating pulse width modulator with control variables, enabling analogue power flow
(c) first, second and third switching device in turn enabling a grouping of red, green and blue light emitting diodes, which are series connected to their respective first, second and third switching devices.
